(19) United States
(12) Patent Application Publication
(10) Pub. No.: US 2009/0216829 A1
(43) Pub. Date: Aug. 27, 2009

(54) NETWORK EQUIPMENT

(75) Inventor: Yasunori Terasaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/388,310

(22) Filed: Feb. 18, 2009

(30) Foreign Application Priority Data
Feb. 22, 2008 (JP) 2008-041550

(51) Int. Cl. G06F 15/16

(52) U.S. Cl. 709/201

(57) ABSTRACT

A network equipment has a group of first stage computing units that perform first stage processing on a packet, and has a group of second stage computing units that perform second stage processing on a packet after the first stage processing. The network equipment assigns the first stage processing that is to be performed on the packet to a computing unit in the group of first stage computing units; generates control information for determining which computing unit in the group of second stage computing units is to be assigned the second stage processing when the computing unit in the group of first stage computing units performs the first stage processing; and determines which computing unit in the group of second stage computing units is to be assigned the second stage processing on the packet based on the control information.

### CROSS-REFERENCE TO RELATED APPLICATIONS

This application is based upon and claims the benefit of priority of the prior Japanese Patent Application No. 2008-41550, filed on Feb. 22, 2008, the entire contents of which are incorporated herein by reference.

### FIELD

The embodiments discussed herein are related to network equipment that processes a received packet.

### BACKGROUND

As Information Technology (IT) systems have become more diversified, higher performance and multiple functions are expected from network equipment such as routers and switches. Even network equipment that achieves faster throughput and performs multiple kinds of processing in parallel is required to maintain a certain level of processing performance.

In order to meet the above-mentioned expectations, network equipment has become more and more dependent on software programs in the Central Processing Unit (CPU) for processing. The recent trend of increasing the CPU clock no longer contributes to improving the performance of network equipment; therefore, parallel processing with a multi-core CPU or a plurality of CPUs is often used to make network equipment faster.

Conventional strategies for making network equipment faster by using parallel processing include a first strategy of performing parallel processing with CPUs all of which are mapped with the same function, and a second strategy of mapping CPUs with different functions and pipelining the functions.

FIG. 12 is a diagram for illustrating the first strategy. As the figure illustrates, in the first strategy, when a CPU selection unit 10 receives a packet, it assigns processing of the packet to CPUs 11 to 13 so that the CPUs 11 to 13 have equal processing loads. Here, it is assumed that the CPUs 11 to 13 have the same functions. Although only the CPUs 11 to 13 are illustrated as an example here, further CPUs are assumed to be included.

FIG. 13 is a diagram for illustrating the second strategy. As the figure illustrates, in the second strategy, pipeline processing is implemented with CPUs 21 to 23, which are assigned different functions and perform processing corresponding to the respective functions.

When a packet is received, the CPU 21 performs the processing corresponding to the function a on the packet, the CPU 22 performs the processing corresponding to the function b on the packet, and the CPU 23 performs the processing corresponding to the function c on the packet. Although only the CPUs 21 to 23 are illustrated as an example here, further CPUs may be included.

Japanese Laid-Open Patent Publication No. 04-181362 discloses a technology of reducing processing overhead by connecting memory instead of by transferring data processed in a preceding stage processor to a subsequent stage processor for further processing.

### SUMMARY

According to an aspect of an embodiment of the invention, a network equipment has a group of first stage computing units that perform first stage processing on a packet, and has a group of second stage computing units that perform second stage processing on a packet after the first stage processing. The network equipment assigns the first stage processing that is to be performed on the packet to a computing unit in the group of first stage computing units; generates control information for determining which computing unit in the group of second stage computing units is to be assigned the second stage processing when the computing unit in the group of first stage computing units performs the first stage processing; and determines which computing unit in the group of second stage computing units is to be assigned the second stage processing on the packet based on the control information.

It is to be understood that both the foregoing general description and the following detailed description are exemplary and explanatory and are not restrictive of the invention, as claimed.

### BRIEF DESCRIPTION OF DRAWINGS

FIG. 1 is a diagram for illustrating the outline and the characteristics of network equipment according to an embodiment;

FIG. 2 is a functional block diagram illustrating a configuration of the network equipment according to the embodiment;

FIG. 3 is a diagram illustrating an exemplary data structure of a packet;

FIG. 4 is a diagram illustrating an exemplary data structure of control data;

FIG. 5 is a diagram illustrating an exemplary data structure of a first assignment managing table;

FIG. 6 is a diagram illustrating an exemplary data structure of a connection policy managing table;

FIG. 7 is a diagram illustrating an exemplary data structure of a second assignment managing table;

FIG. 8 is a diagram illustrating an exemplary data structure of a contents policy managing table;

FIG. 9 is a diagram illustrating an exemplary data structure of a third assignment managing table;

FIG. 10 is a diagram illustrating an exemplary data structure of a queue policy managing table;

FIG. 11 is a diagram illustrating a hardware configuration of a computer that constitutes the network equipment according to the embodiment;

FIG. 12 is a diagram for illustrating a first strategy (conventional art); and

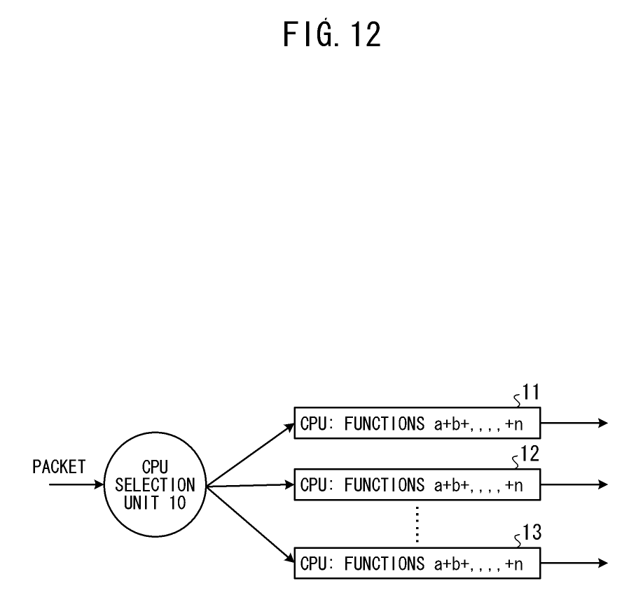

FIG. 13 is a diagram for illustrating a second strategy (conventional art).

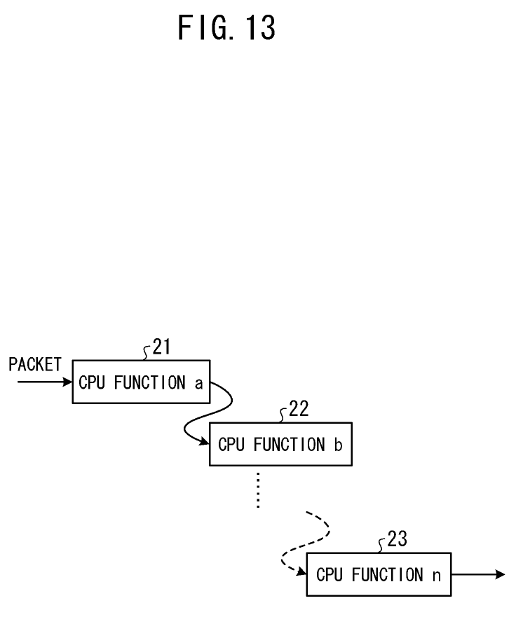

### DESCRIPTION OF EMBODIMENTS

Embodiments of the network equipment and the network processing program according to the present invention will be detailed below with reference to the drawings.

### Embodiments

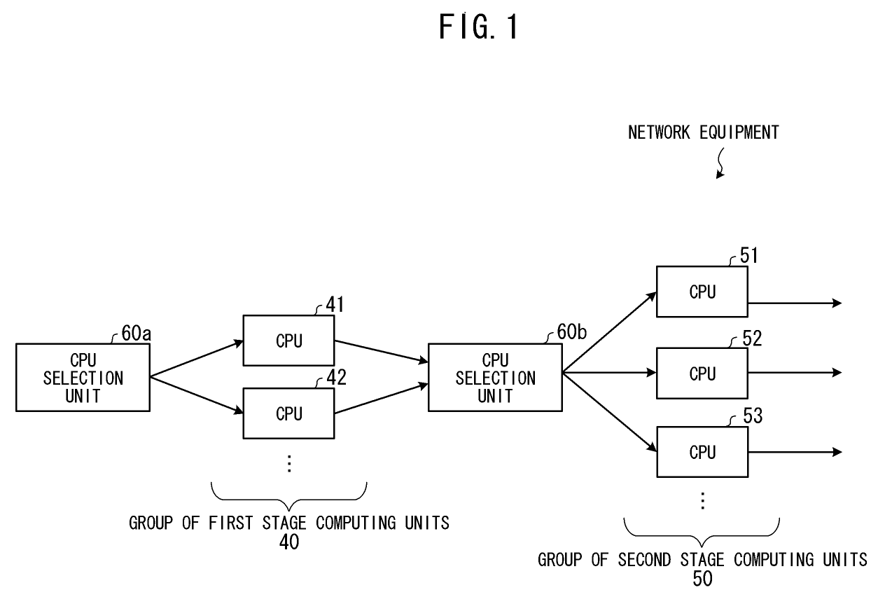

First, the outline and the characteristics of the network equipment according to the embodiment will be described. FIG. 1 is a diagram for illustrating the outline and the characteristics of the network equipment according to the embodiment. As the figure illustrates, the network equipment has a group of first stage computing units 40 that includes Central Processing Units (CPUs) 41 and 42 that perform first stage processing; a group of second stage computing units 50 that includes CPUs 51 to 53 that perform second stage processing after the first stage processing; a CPU selection unit 60a that assigns the first stage processing to a CPU in the group of first stage computing units 40; and a CPU selection unit 60b that assigns the second stage processing to a CPU in the group of second stage computing units 50.

Although it is illustrated that the group of first stage computing units 40 has the CPUs 41 and 42 and the group of second stage computing units 50 has the CPUs 51, 52 and 53 as an example here, it is assumed that the group of first stage computing units 40 and the group of second stage computing units 50 may each have more CPUs.

When the network equipment receives a packet, it assigns the first stage processing to be performed on the packet to a CPU in the group of first stage computing units 40. Then, the CPU that is assigned the first stage processing performs the first stage processing, and also generates control information and outputs that information to the CPU selection unit 60b. The CPU selection unit 60b refers to the control information that is output from the group of first stage computing units 40 and assigns the second stage processing to a CPU in the group of second stage computing units 50.

Here, the control information is the data which the CPU selection unit 60b references in assigning the second stage processing to the CPU in the group of second stage computing units 50. The control information includes information contained in a header for each layer of the packet.

The network equipment according to the embodiment can save the CPU selection unit 60b from having to extract necessary information from the packet again by itself when assigning the second stage processing to the CPUs 51 to 53, because the CPU that performs the first stage processing previously generates such control information for the CPU selection unit 60b to reference and outputs it to the CPU selection unit 60b. In this way, the embodiment has achieved faster network equipment processing by reducing the processing load on the CPU selection unit 60b.

Although only the group of first stage computing units 40, the group of second stage computing units 50, and the CPU selection units 60a and 60b corresponding to the groups of computing units at respective stages are illustrated, the above-mentioned network equipment may include further groups of third to n^{th} (n>3) stage computing units and CPU selection units corresponding to the groups of computing units at respective stages.

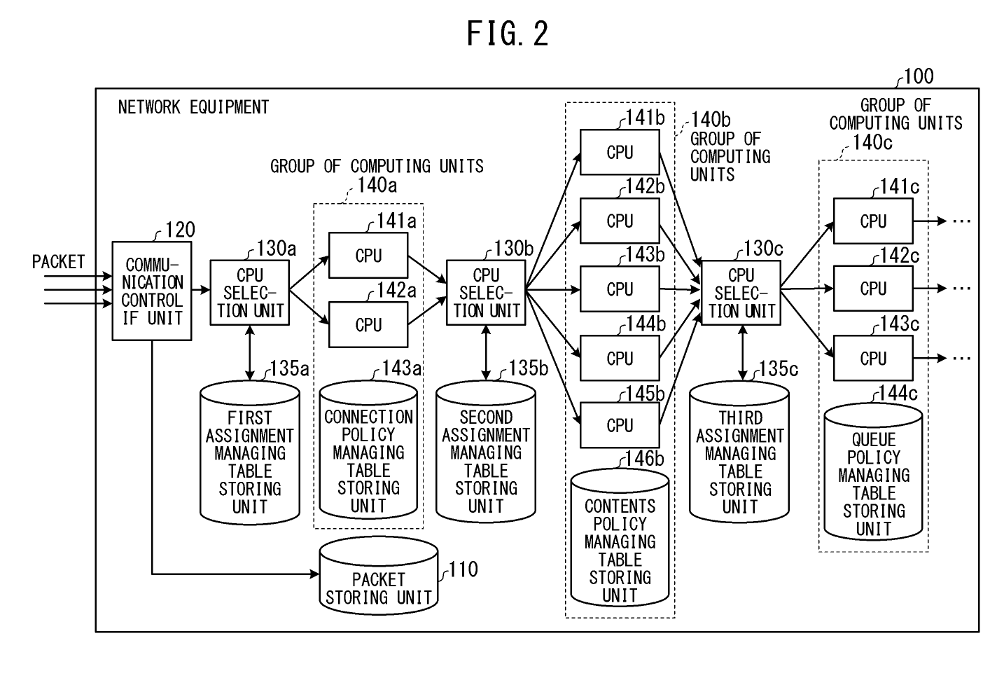

Now, the network equipment according to the embodiment will be described in detail. FIG. 2 is a functional block diagram illustrating a configuration of the network equipment according to the embodiment. As the figure illustrates, the network equipment 100 includes a packet storing unit 110, a communication control IF unit 120, CPU selection units 130a, 130b and 130c, a first assignment managing table storing unit 135a, a second assignment managing table storing unit 135b, a third assignment managing table storing unit 135c, and groups of computing units 140a, 140b and 140c. As the other components are the same as those in known switches, routers and the like, their explanations are omitted here.

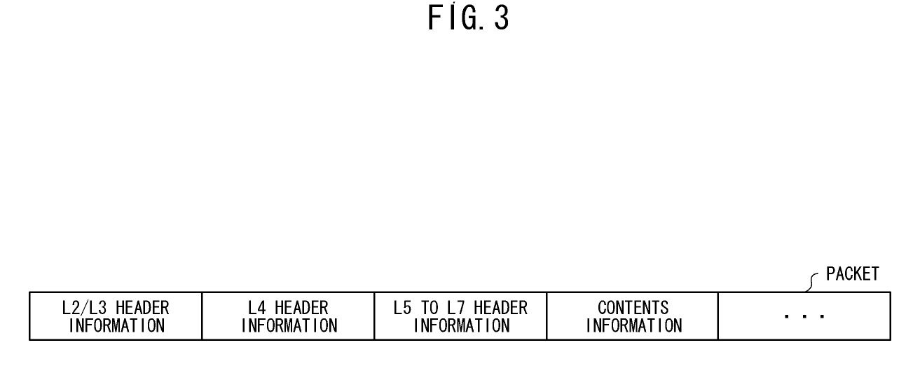

The packet storing unit 110 here stores a packet that is output from the communication control IF unit 120. FIG. 3 is a diagram illustrating an exemplary data structure of a packet. As the figure illustrates, the packet includes Layer2 and Layer3 (L2/L3) header information, L4 header information, L5 to L7 header information, and contents information.

Here, the L2/L3 header information is information on a destination address (DA), a source address (SA), and the like that are used in the data link layer or the network layer. The L4 header information is information such as a port number, which is a number assigned to a port through which the network equipment 100 receives the packet, that is also used in the transport layer.

The L5 to L7 header information, for example, is information that is used in the session layer, the presentation layer, and the application layer, including information on a Cookie and the like. The contents information is the information on various contents (for example, a document, a sound, an image and the like).

The communication control IF unit 120 controls data communication with an external communication device via a network. The communication control IF unit 120 stores a received packet in the packet storing unit 110, and also generates control data from the packet and outputs the generated control data to the CPU selection unit 130a.

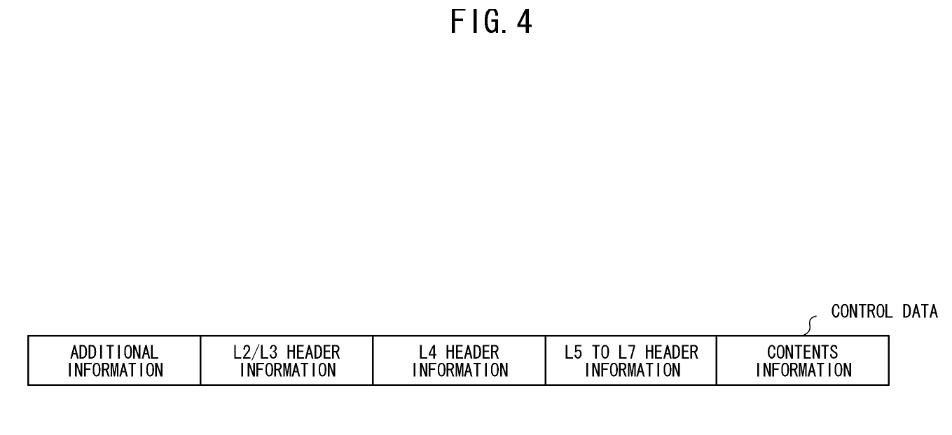

FIG. 4 is a diagram illustrating an exemplary data structure of control data. As the figure illustrates, the control data includes additional information, the L2/L3 header information, the L4 header information, the L5 to L7 header information, and contents information.

Here, the additional information is a field for storing information to be generated by a CPU in the groups of computing units 140a to 140c to be described below. Therefore no information is kept in the additional information field when the communication control IF unit 120 generates the control data. As the L2/L3 header information, the L4 header information, the L5 to L7 header information, and the contents information included in the control data are the same as those included in the packet illustrated in FIG. 3, their explanations are omitted here.

The CPU selection unit 130a, in response to obtaining the control data from the communication control IF unit 120, generates a first assignment managing table based on the information in the L3 header and information in the L4 header that is included in the control data, stores the first assignment managing table in the first assignment managing table storing unit 135a, and also assigns the first stage processing to either of the CPUs 141a and 142a based on the first assignment managing table by outputting the control data to the assigned CPU.

In the embodiment, the first stage processing is assumed as processing for each connection. Here, the processing for each connection is assumed as processing corresponding to Firewall (FW) processes such as approval of the passage of a packet, instruction to discard a packet, and the like.

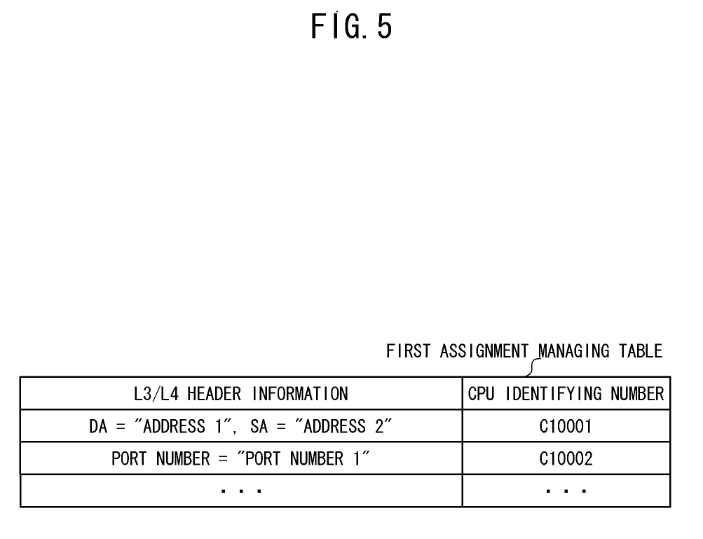

FIG. 5 is a diagram illustrating an exemplary data structure of the first assignment managing table. As the figure illustrates, the first assignment managing table includes the L3/L4 header information and a CPU identifying number. The L3/L4 header information is information, such as DA/SA, port number and the like, used in either the network layer or the transport layer. The CPU identifying number is information for identifying a CPU. For example, the CPU identifying number “C10001” corresponds to the CPU 141a, and the CPU identifying number “C10002” corresponds to the CPU 142a.

According to FIG. 5, if the control data includes the information DA=“Address 1,” SA=“Address 2,” the CPU selection unit 130a assigns the first stage processing to the CPU 141a. Or if the control data includes the information Port number=“Port number 1,” the CPU selection unit 130a assigns the first stage processing to the CPU 142a.

Here, it is assumed that the first stage processing assigned by the first assignment managing table is set such that it is not subjected to the exclusive control by the CPUs 141a and 142a in the group of computing units 140a. For example, the CPU selection unit 130a holds information on combinations of L3/L4 header information and information on shared resources that are used by the CPUs according to the L3/L4 header information in advance. Based on the information on combinations, the CPU selection unit 130a generates the first assignment managing table so that the CPUs do not perform exclusive control.

That is, in FIG. 5, the shared resources used by the CPU that performs processing according to the L3/L4 header information differs from the shared resources used by the CPU that performs processing according to the L3/L4 header information.

The group of computing units 140a includes the CPUs 141a and 142a and a connection policy managing table storing unit 143a, and performs the first stage processing for the connection units. Here, the connection policy managing table storing unit 143a stores a connection policy managing table.

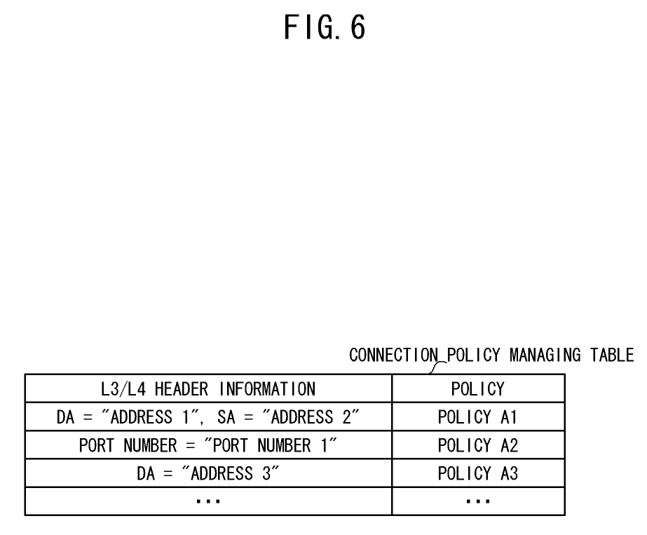

The connection policy managing table is a table for storing L3/L4 header information and policies in association with each other. FIG. 6 is a diagram illustrating an exemplary data structure of the connection policy managing table. For example, in FIG. 6, the CPU that obtains the control data including DA=“Address 1,” SA=“Address 2” performs the processing according to the policy “Policy A1.”

The CPUs 141a and 142a, in response to obtaining the control data from the CPU selection unit 130a, determine a policy by comparing the L3/L4 header information included in the obtained control data and the connection policy managing table (see FIG. 6), and perform the processing according to the determined policy.

The CPUs 141a and 142a store the processing result in the additional information field (see FIG. 4), extract the information, such as cookies, included in the L5 to L7 header information in place of the CPU selection unit 130b, and store the extracted information in the additional information field. Then, the CPUs 141a and 142a output the processing result, Cookies and other control data stored in the additional information field, to the CPU selection unit 130b.

The CPU selection unit 130b, in response to obtaining the control data from the group of computing units 140a (CPU 141a or 142a), generates a second assignment managing table based on the Cookie that is included in the additional information of the control data, stores the second assignment managing table in the second assignment managing table storing unit 135b, and also assigns the second stage processing to any of the CPUs 141b to 145b based on the second stage managing table by outputting the control data to the assigned CPU.

In the embodiment, the second stage processing is assumed as processing for each of the contents. Here, the processing for each of the contents is assumed as processing corresponding to, for example, Server Load Balancing (SLB) and the like.

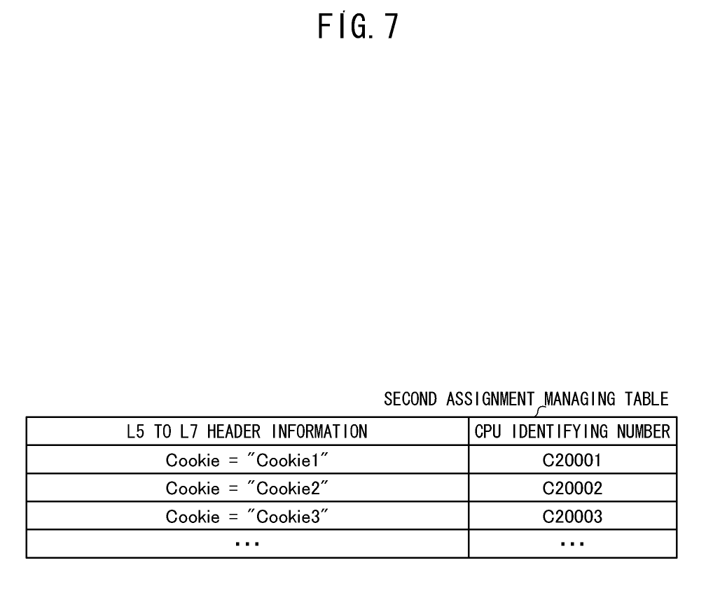

FIG. 7 is a diagram illustrating an exemplary data structure of the second assignment managing table. As the figure illustrates, the second assignment managing table includes the L5 to L7 header information and the CPU identifying number. The L5 to L7 header information is information used in the session layer, the presentation layer, and the application layer, for example Cookies and the like. The CPU identifying number is information for identifying a CPU. For example, the CPU identifying number “C20001” corresponds to the CPU 141b, the CPU identifying number “C20002” corresponds to the CPU 142b, and the CPU identifying number “C20003” corresponds to the CPU 143b.

According to FIG. 7, if the additional information of the control data includes the information Cookie=“Cookie1,” the CPU selection unit 130b assigns the second stage processing to the CPU 141b. If the additional information of the control data includes the information Cookie=“Cookie2,” the CPU selection unit 130b assigns the second stage processing to the CPU 142b. Or if the additional information of the control data includes the information Cookie=“Cookie3,” the CPU selection unit 130b assigns the second stage processing to the CPU 143b.

In this way, the CPU selection unit 130b can determine the CPU to be assigned the second stage processing by referencing only the additional information of the control data. Thus, the CPU selection unit 130b does not need to extract the necessary information from each piece of the header information of the control data again, which significantly reduces the load in the assignment processing.

Here, it is assumed that the second stage processing assigned by the second assignment managing table is set such that it is not subjected to the exclusive control by the CPUs 141b to 145b in the group of computing units 140b. For example, the CPU selection unit 130b keeps information on combinations of L5 to L7 header information and information on shared resources that are used by the CPUs according to the L5 to L7 header information in advance. Based on the information on combinations, the CPU selection unit 130b generates the second assignment managing table so that the CPUs do not perform exclusive control.

That is, in FIG. 7, the shared resource used by the CPU that performs processing according to the L5 to L7 header information Cookie=“Cookie1,” the shared resource used by the CPU that performs processing according to the L5 to L7 header information Cookie=“Cookie2,” and the shared resource used by the CPU that performs processing according to the L5 to L7 header information Cookie=“Cookie3” differ from one another.

The group of computing units 140b includes the CPUs 141b to 145b and a contents policy managing table storing unit 146b and performs the second stage processing for each of the contents. Here, the contents policy managing table storing unit 146b stores a contents policy managing table.

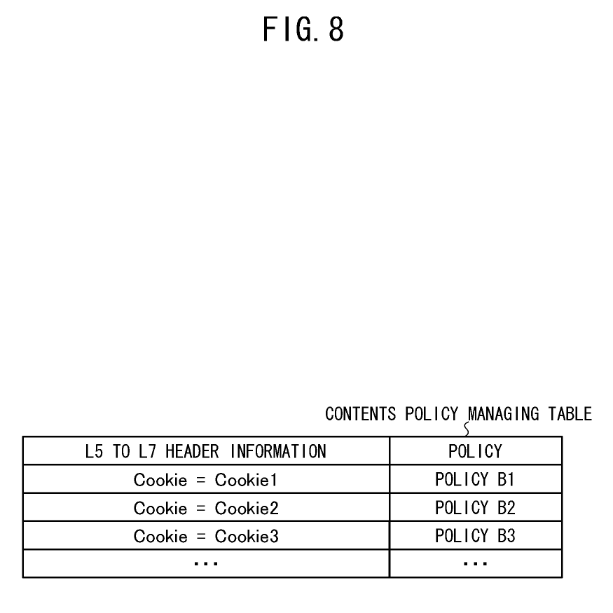

The contents policy managing table is a table for storing the L5 to L7 header information and the policies in association with each other. FIG. 8 is a diagram illustrating an exemplary data structure of the contents policy managing table. For example, in the case illustrated in FIG. 8, the CPU that receives the control data including Cookie=“Cookie1” in the additional information performs the processing according to the policy “Policy B1.”

The CPUs 141b to 145b, in response to obtaining the control data from the CPU selection unit 130b, determine a policy by comparing the L5 to L7 header information included in the obtained control data and the contents policy managing table (see FIG. 8), and perform the processing according to the determined policy.

The CPUs 141b to 145b store the processing result in the additional information field (see FIG. 4), extract the information included in the L5 to L7 header information, such as a Cookie, in place of the CPU selection unit 130c, and store the extracted information in the additional information field. Then, the CPUs 141b to 145b output the control data, which has the processing result and L5 to L7 header information stored in the additional information field, to the CPU selection unit 130c.

The CPU selection unit 130c, in response to obtaining the control data from the group of computing units 140b, generates a third assignment managing table based on the processing result included in the additional information of the control data, which is the processing result of either of the CPUs 141a and 142a in the group of computing units 140a, or the processing result of any of the CPUs 141b to 145b in the group of computing units 140b, based on the L5 to L7 header information. The CPU selection unit 130c stores the third assignment managing table in the third assignment managing table storing unit 135c, and assigns the third stage processing to any of the CPUs 141c to 143c based on the third stage managing table by outputting the control data to the assigned CPU.

In the embodiment, the third stage processing is assumed as processing for each queue. Here, the processing for each queue is assumed as processing corresponding to the Quality of Service (QOS) and the like.

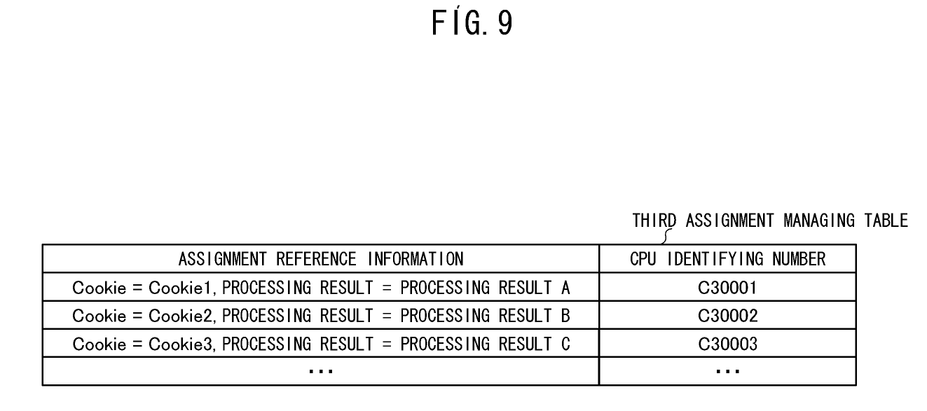

FIG. 9 is a diagram illustrating an exemplary data structure of the third assignment managing table. As the figure illustrates, the third assignment managing table includes assignment reference information and the CPU identifying number for identifying a CPU. The assignment reference information is information including the L5 to L7 header information, such as a Cookie, and the processing result of either of the CPUs 141a and 142a in the group of computing units 140a or the processing result of any of the CPUs 141b to 145b in the group of computing units 140b.

The CPU identifying number “C30001” corresponds to the CPU 141c, the CPU identifying number “C30002” corresponds to the CPU 142c, and the CPU identifying number “C30003” corresponds to the CPU 143c.

According to FIG. 9, if the additional information of the control data includes information of Cookie=“Cookie1,” and the processing result=“Processing result A,” the CPU selection unit 130c assigns the third stage processing to the CPU 141c. If the additional information of the control data includes information of Cookie=“Cookie2” and the processing result=“Processing result B,” the CPU selection unit 130c assigns the third stage processing to the CPU 142c. If the additional information of the control data includes information of Cookie=“Cookie3” and the processing result=“Processing result C,” the CPU selection unit 130c assigns the third stage processing to the CPU 143c.

In this way, the CPU selection unit 130c can determine the CPU to be assigned the third stage processing by referencing only the additional information of the control data. Therefore, the CPU selection unit 130c does not need to extract the necessary information again from each piece of the header information of the control data or to obtain the processing result from the groups of computing units 140a and 140b. Thus, the load in the assignment processing is significantly reduced.

Here, it is assumed that the third stage processing assigned by the third assignment managing table is set such that it is not subjected to the exclusive control by the CPUs 141c to 143c in the group of computing units 140c. For example, the CPU selection unit 130c holds information on combinations of L5 to L7 header information and the processing result, and information on shared resources that are used by the CPUs according to the L5 to L7 header information and the processing result in advance. Based on the information on combinations, the CPU selection unit 130c generates the third assignment managing table so that the CPUs do not perform exclusive control.

That is, in FIG. 9, the shared resource used by the CPU that performs processing according to the assignment reference information, Cookie=“Cookie1” and the processing result=“Processing result A,” the shared resource used by the CPU that performs processing according to the assignment reference information Cookie=“Cookie2” and the processing result=“Processing result B,” and the shared resource used by the CPU that performs processing according to the assignment reference information Cookie=“Cookie3” and the processing result=“Processing result C” differ from one another.

The group of computing units 140c includes the CPUs 141c to 143c and a queue policy managing table storing unit 144c, and performs the third stage processing for each queue. Here, the queue policy managing table storing unit 144c stores a queue policy managing table.

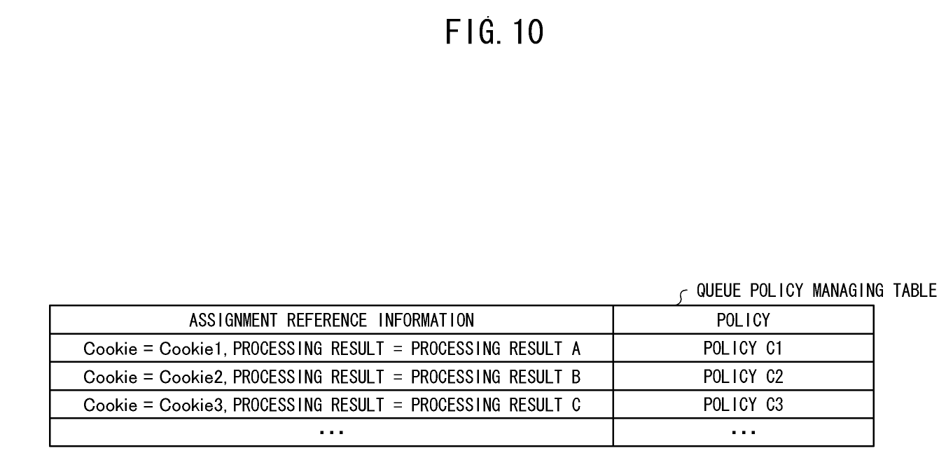

The queue policy managing table is a table for storing the assignment reference information and the policies in association with each other. FIG. 10 is a diagram illustrating an exemplary data structure of the queue policy managing table. For example, in the case illustrated in FIG. 10, the CPU that receives the control data, which has Cookie=“Cookie1” and the processing result=“Processing result A” in the additional information field, performs the processing according to the policy “Policy C1.”

The CPUs 141c to 143c, in response to obtaining the control data from the CPU selection unit 130c, determine a policy by comparing the L5 to L7 header information and the processing result included in the obtained control data and the queue policy managing table, and perform the processing according to the determined policy.

If a CPU selection unit (not shown) is connected subsequent to the group of computing units 140c, the CPUs 141c to 143c extract the information, which the subsequent stage CPU selection unit needs in selecting a CPU, from the control data, store the extracted data in the additional information, and then output the extracted data to the CPU selection unit.

As mentioned above, in the network equipment 100 according to the embodiment, the CPU selection unit 130a receives control data and assigns the first stage processing to a CPU in the group of computing units 140a. Then, the CPU that is assigned the first stage processing performs the first stage processing generates the additional information to be used by the CPU selection unit 130b, stores the generated additional information in the control data, and outputs the additional information to the CPU selection unit 130b. The CPU selection unit 130b assigns the second stage processing to a CPU in the group of computing units 140b based on the additional information. Therefore, the CPU selection unit 130b does not need to extract the necessary information again from each piece of the header information of the packet by itself. This significantly reduces the load in the assignment processing. Thus, the performance of the network equipment 100 can be improved.

Using either a multi-core CPU or using a plurality of CPUs for parallel processing is a realistic approach to improving the processing performance of increasingly multi-purpose, high-performance network processing equipment. However, simply conducting parallel processing cannot be expected to improve performance. To address the performance bottleneck, the network equipment 100 with the above-mentioned architecture has addressed the problem of exclusive control between CPUs by classifying the functions into groups on the basis of the function, by assigning the CPUs to the groups by stages, and by performing the parallel processing to meet the required performance. The network equipment 100 with the above-mentioned architecture has also addressed the problem of assignment processing, which lowers the performance of the parallel processing, by decentralizing the assignment processing in the preceding stage parallel processing and by conducting identification processing.

The network equipment 100 is adapted to be able to respond to higher functionality and higher performance in the future, since it can respond to a further demand of expansion by mapping the function to a corresponding CPU in consideration of the functional base or policy, and also by increasing the number of CPUs to meet the required performance.

All or a part of the processing that has been described as automatic in the embodiment may be done manually, and all or a part of the processing that has been described as manual may be done automatically with generally known methods. The procedures, the control procedures, the specific names, and information including various kinds of data and parameters that have been described in the specification and illustrated in the drawings may be altered, unless specified in particular.

FIG. 2 provides a functional and conceptual perspective of the components of the network equipment 100. Thus, the network equipment 100 does not need to be physically configured as illustrated in the figure. That means the decentralization and integration of the components are not limited to those illustrated in FIG. 2, and all or some of the components may be functionally or physically decentralized or integrated according to each kind of load and usage. All or a part of the processing functionality implemented by the components may be performed by a CPU and a program that is analyzed and executed by the CPU, or may be implemented as hardware with wired logic.

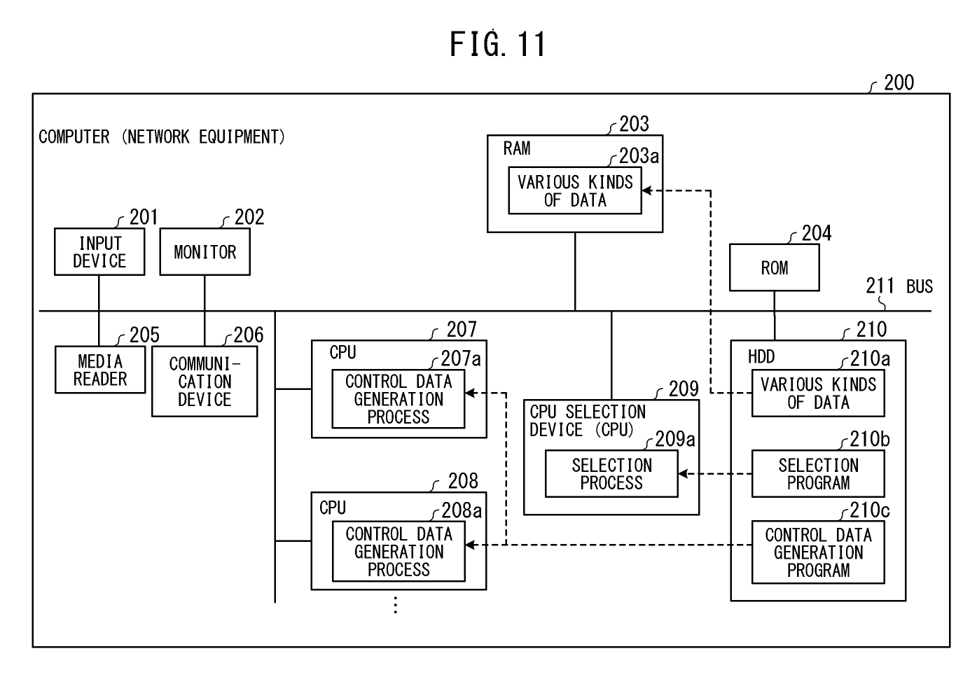

FIG. 11 is a diagram illustrating an example of a hardware configuration of a computer 200 that constitutes the network equipment 100 according to the embodiment. As the figure illustrates, the computer 200 includes an input device 201, a monitor 202, a Random Access Memory (RAM) 203, a Read Only Memory (ROM) 204, a media reader 205 for reading data from a storage medium, a communication device 206 for exchanging data with other equipment, CPUs 207 and 208, a CPU selection device 209, and a Hard Disk Drive (HDD) 210, all of which are connected via a bus 211. Although only the CPUs 207 and 208 are illustrated as examples here, the computer 200 is assumed to include other CPUs.

In the HDD 210, a selection program 210b and a control data generation program 210c that provide the same functions as those of the above-mentioned network equipment 100 are stored. A selection process 209a is started by the CPU selection device 209 reading out and executing the selection program 210b. The selection process 209a corresponds to the CPU selection units 130a, 130b, and 130c illustrated in FIG. 2.

A control data generation process 207a is started by the CPU 207 reading out and executing the control data generation program 210c. The control data generation process 207a corresponds to the processing executed by the CPUs in the groups of computing units 140a, 140b, and 140c. Similarly, a control data generation process 208a is started by the CPU 208 reading out and executing the control data generation program 210c. The control data generation process 208a corresponds to the processing executed by the CPUs in the groups of computing units 140a, 140b, and 140c.

The HDD 210 also stores various kinds of data 210a that correspond to the first assignment managing table, the second assignment managing table, the third assignment managing table, the connection policy managing table, the contents policy managing table, and the queue policy managing table. The CPUs 207 and 208 and the CPU selection device 209 read out and execute the various kinds of data 210a that are stored in the HDD 210 and store them in the RAM 203. Using the various kinds of data 203a stored in the RAM 203, the CPU selection device 209 assigns the processing to the CPUs 207 and 208, and the CPUs 207 and 208 generate the additional information and store it as the various kinds of data 203a.

The selection program 210b and the control data generation program 210c illustrated in FIG. 11 may be stored in a computer-readable storage medium such as a HDD, a flexible disk (FD), a CD-ROM, a DVD disk, a magneto-optical disk, and an IC card. The selection program 210b and the control data generation program 210c illustrated do not need to be stored in the HDD 210 from the beginning. The embodiment may be accomplished by a computer reading out and executing the selection program 210b and the control data generation program 210c from a portable physical medium which is inserted into the computer such as a flexible disk (FD), a CD-ROM, a DVD disk, a magneto-optical disk, and an IC card; from a fixed physical medium which may be provided inside or outside the computer such as a Hard Disk Drive. The selection program 210b and the control data generation program 210c may be received or downloaded from another computer or server which is connected to the computer by a public network, the Internet, a LAN, or a WAN, in which the selection program 210b and the control data generation program 210c have been stored.

What is claimed is:

1. Network equipment for processing a packet received over a network with a plurality of computing units, comprising;
a group of first stage computing units comprises a plurality of computing units that perform first stage processing on the packet;
a group of second stage computing units comprises a plurality of computing units that perform second stage processing on the packet after the first stage processing;
a first assigning unit that assigns the first stage processing that is to be performed on the packet to a computing unit in the group of first stage computing units;
a control information generating unit that generates control information for determining which computing unit in the group of second stage computing units is to be assigned the second stage processing, when the computing unit in the group of first stage computing units performs the first stage processing; and
a second assigning unit that determines which computing unit in the group of second stage computing units is to be assigned the second stage processing on the packet based on the control information.

2. The network equipment according to claim 1, wherein the control information is information contained in a header corresponding to each layer of the packet.

3. The network equipment according to claim 1, wherein the computing units are allocated to the group of first stage computing units or the group of second stage computing units according to functions of the computing units.

4. The network equipment according to claim 2, wherein the computing units are allocated to the group of first stage computing units or the group of second stage computing units according to functions of the computing units.

5. A computer readable storage medium storing a network processing program for causing a computer to execute procedures, the computer comprises a group of first stage computing units and a group of second stage computing units; the group of first stage computing units comprises a plurality of computing units that perform first stage processing on a received packet and the group of second stage computing units comprises a plurality of computing units that perform second stage processing that is performed after the first stage processing, the procedures comprising;
assigning the first stage processing that is to be performed on the packet to a computing unit in the group of first stage computing units;
generating control information for determining which computing unit in the group of second stage computing units is to be assigned the second stage processing, when the computing unit in the group of first stage computing units performs the first stage processing; and
determining which computing unit in the group of second stage computing units is to be assigned the second stage processing on the packet based on the control information.

6. The computer readable storage medium in which a network processing program is recorded according to claim 5, wherein the control information is information contained in a header corresponding to each layer of the packet.

7. The computer readable storage medium in which a network processing program is recorded according to claim 5, wherein the computing units are allocated to the group of first stage computing units or the group of second stage computing units according to functions of the computing units.

8. The computer readable storage medium in which a network processing program is recorded according to claim 6, wherein the computing units are allocated to the group of first stage computing units or said group of second stage computing units according to functions of the computing units.
